(19) United States
(12) Patent Application Publication
(10) Pub. No.: US 2017/0274714 A1
(43) Pub. Date: Sep. 28, 2017

(54) FRICTION SWAY CONTROL FOR TRAILERS

(71) Applicant: Keystone Automotive Operations, Inc., Exeter, PA (US)

(72) Inventors: Rodney Peterson, Elkhart, IN (US); David Hoover, White Pigeon, MI (US); Peter Bolenbaugh, Elkhart, IN (US); Christopher Moore, Elkhart, IN (US)

(73) Assignee: Keystone Automotive Operations, Inc., Exeter, PA (US)

(21) Appl. No.: 15/079,383

(22) Filed: Mar. 24, 2016

(51) Int. Cl. B60D 1/32; B60D 1/06

(52) U.S. Cl. CPC B60D 1/325; B60D 1/06

(57) ABSTRACT

The present disclosure is directed toward sway control systems for adjustably controlling sway between a trailer and towing vehicle through use of frictional forces that include a tow bar assembly, a connector assembly, a tensioner spanning the width of the housing of the tow bar assembly, and a crank assembly. Within the tow bar assembly, a slide bar is frictionally engaged with the housing, and the relative friction may be controlled by increasing or decreasing compression of the at least one brake pad through adjustment of the compression plate toward or away from the interconnecting web. The present disclosure attempts to improve ease of use by utilizing a single adjustment point.

### FIELD OF THE DISCLOSURE

This disclosure relates to friction sway controls for connection between a trailer and a towing vehicle. More particularly, the disclosure relates to systems and methods for adjustably reducing lateral movement of the trailer relative to the towing vehicle.

### BACKGROUND OF THE DISCLOSURE

Sway between a vehicle and a trailer is a common problem, particularly when that sway is unanticipated by a driver of the vehicle. This sway is caused by wind and road conditions, and is a function, in part, of vehicle speed in combination with inherent characteristics of a ball and socket joint of the type typically used to connect a trailer to a towing vehicle. Unanticipated sway can cause a driver to lose control, so there have been various attempts to limit sway of a trailer relative to a towing vehicle.

For example, it is known that a sway control system may be attached between a trailer and a towing vehicle to help minimize trailer sway. Such sway control systems often utilize frictional forces to combat lateral movement of the trailer. Relative friction may be controlled by increasing or decreasing compression of the at least one brake pad through adjustment of a compression plate toward or away from an interconnecting web.

Examples of such systems are disclosed in U.S. Pat. No. 3,294,421, U.S. Pat. No. 4,165,885, U.S. Pat. No. 4,306,734, U.S. Pat. No. 5,222,754, U.S. Pat. No. 6,158,759, U.S. Pat. No. 6,279,693, U.S. Pat. No. 6,397,985, U.S. Pat. No. 8,186,702, and U.S. D335853. The disclosures of these and all other publications referenced herein are incorporated by reference in their entirety for all purposes.

### SUMMARY OF THE DISCLOSURE

The present disclosure is directed toward sway control systems for adjustably controlling sway between a trailer and towing vehicle through use of frictional forces that include a tow bar assembly, a connector assembly, a tensioner spanning the width of the housing of the tow bar assembly, and a crank assembly.

The present disclosure is additionally directed to friction sway controls that include a tow bar assembly including a housing and within the housing, a slide bar is frictionally engaged with the housing by at least one brake pad.

The present disclosure is yet additionally directed to friction sway controls that include a tensioner. The tensioner is a compression plate that spans the width of the housing, and by adjusting the plate toward or away from the interconnecting web of the housing a user is able to increase or decrease the relative friction between the slide bar and the housing. Additionally, the compression plate is formed such that one end fits into the slot on one of the upper flange and lower flange of the housing and the other end contains an elongated hole that aligns with a threaded fastener.

The present disclosure is yet additionally directed to friction sway controls that include a crank assembly. The crank assembly includes a handle and a bolt, the bolt being configured to extend through the elongated hole of the compression plate and thread with the threaded fastener.

Advantages of the present disclosure will be more readily understood after considering the drawings and the Detailed Description.

### BRIEF DESCRIPTION OF THE DRAWINGS

FIG. 1 shows an isometric view of a sway control attached to a tongue of a trailer and a ball mount of a towing vehicle, according to aspects of the present teachings.

FIG. 2 shows an isometric view of the sway control of FIG. 1, unattached to any external elements, and having a slide bar in a stowed position within a housing.

FIG. 3 shows an isometric view of the sway control of FIGS. 1-2, unattached to any external elements, and having the slide bar in an extended position within the housing.

FIG. 4 shows an isometric view of the sway control of FIGS. 1-3, unattached to any external elements, and having the slide bar, a compression plate, and a crank removed from the housing.

FIG. 5 shows a back view of the compression plate of FIGS. 1-4.

FIG. 6 shows a side view of the compression plate of FIGS. 1-5.

The drawings illustrate embodiments and schematic concepts for friction sway control for trailers according to the invention. The purpose of these drawings is to aid in explaining the principles of the invention. Thus, the drawings should not be considered as limiting the scope of the invention to the embodiments and schematic concepts shown therein. Other embodiments of friction sway control for trailers may be created which follow the principles of the invention as taught herein, and these other embodiments are intended to be included within the scope of patent protection.

### DETAILED DESCRIPTION OF THE DISCLOSURE

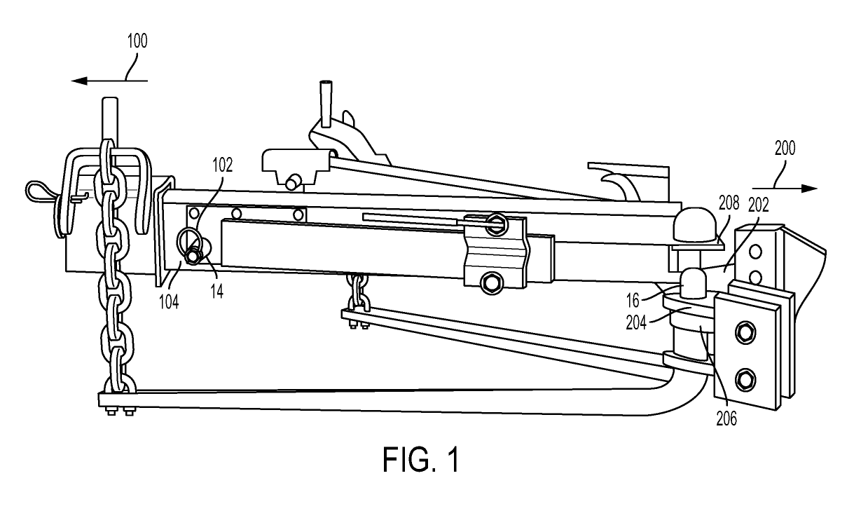

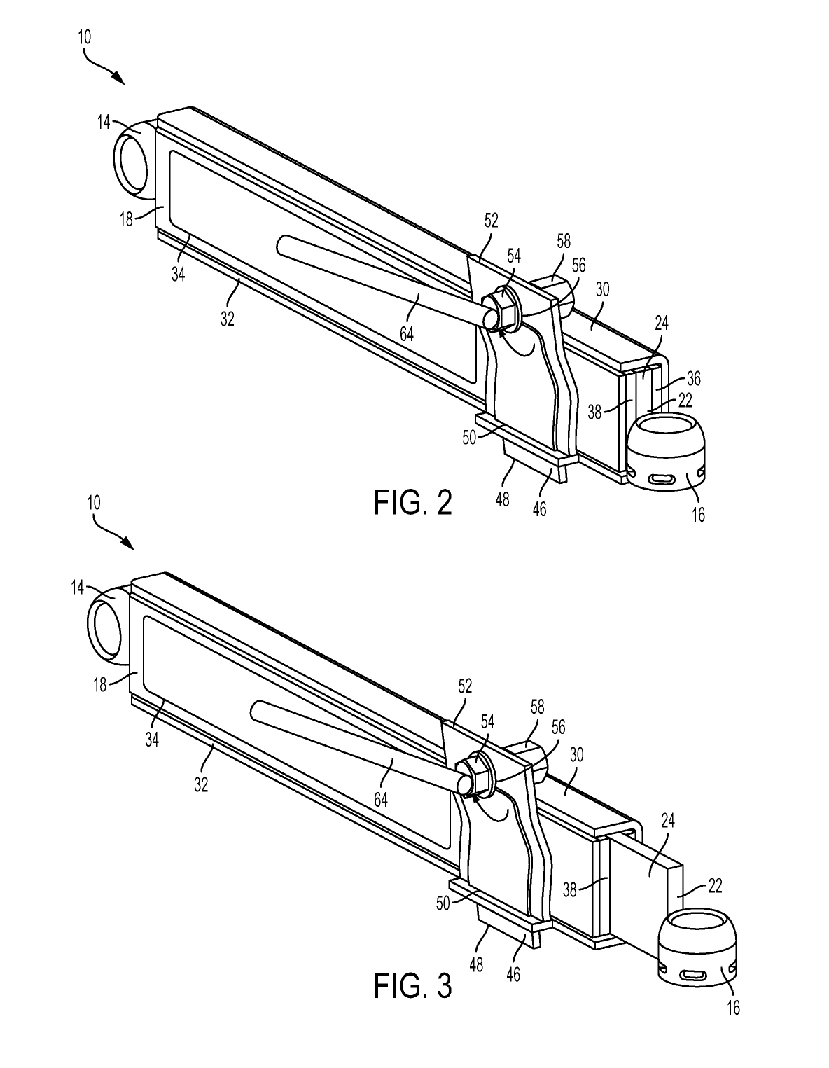

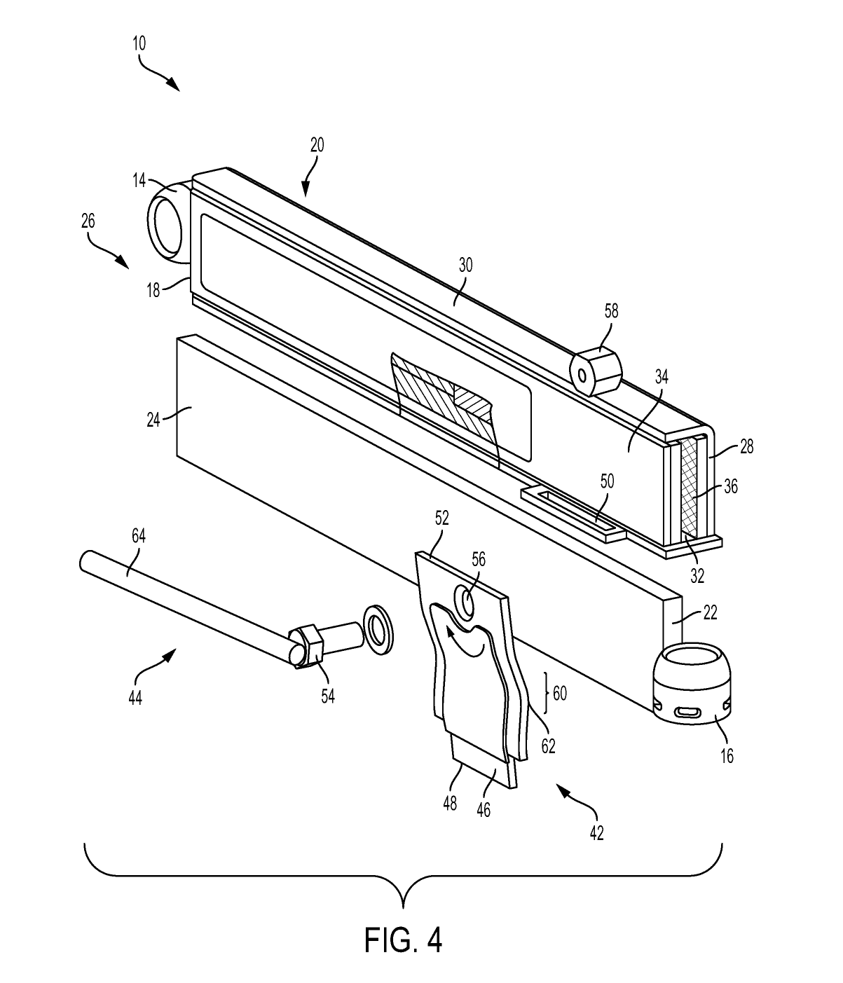

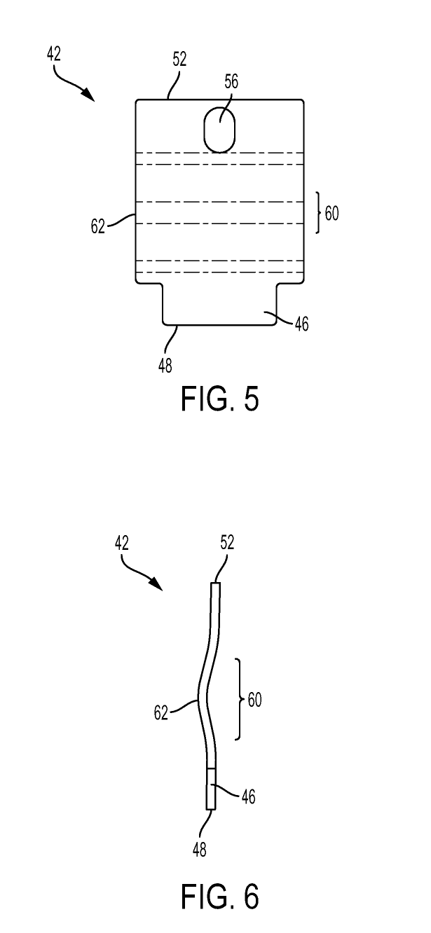

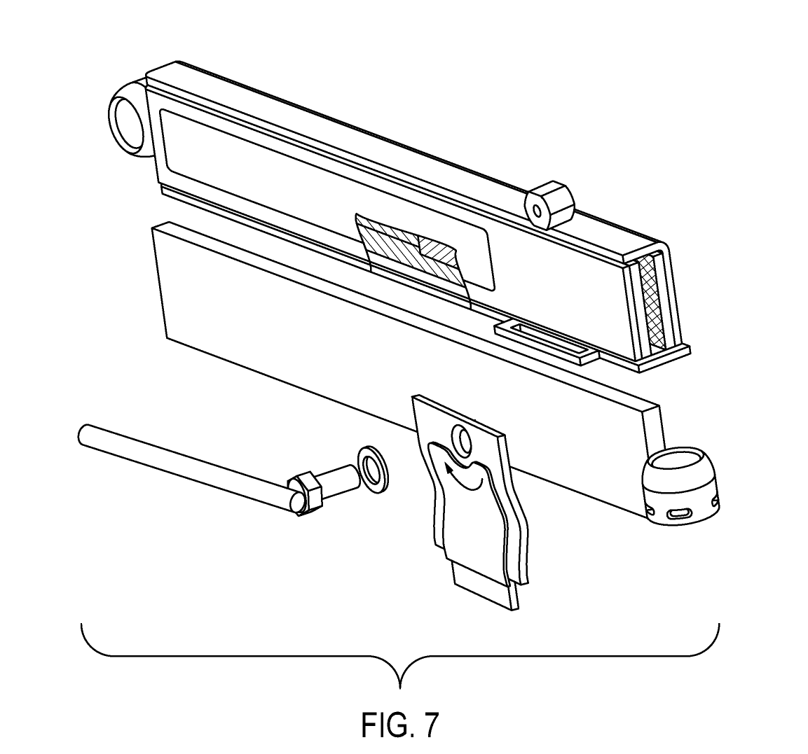

Examples of a friction sway control are shown in FIGS. 1-6. Unless otherwise specified, a friction sway control may, but is not required to contain at least one of the structure, components, functionality, and/or variations described, illustrated, and/or incorporated herein. One purpose of the sway controls in this disclosure is to improve ease of use through a simplified design. This simplified design has additional benefits by reducing the number of necessary components.

The friction sway control of this disclosure is designated by reference numeral 10 and is for controlling sway of a trailer 100 relative to a towing vehicle 200. The friction sway control 10 is for connection between the trailer 100 and the towing vehicle 200. The friction sway control 10 connects to the trailer 100 and the towing vehicle 200 through use of a pair of connectors 12.

The pair of connectors 12 include a trailer connector 14, for example a tongue ball socket, and a towing vehicle connector 16, for example a sway ball socket, disposed on a trailer end 18 of a housing 20 and on a towing vehicle end 22 of a slide bar 24, respectively. The connectors are configured to couple with a tongue ball 102 disposed on a tongue 104 and a trailer hitch 202, for example a sway control ball 204, disposed on a ball mount 206, respectively.

The friction sway control 10 includes a tow bar assembly 26 having the housing 20 that includes a C-beam having an interconnecting web 28, an upper flange 30, and a lower flange 32, and a front panel 34. The housing 20 is connected to the trailer 200 on the trailer end 18 by the trailer connector 14.

The tow bar assembly 26 further includes the slide bar 24 that is slidably mounted within the housing 20. The slide bar 24 is connected to the towing vehicle 200 on the towing vehicle end 22 by the towing vehicle connector 16.

The tow bar assembly 26 provides frictional forces that oppose lateral movement of trailer 100 relative to towing vehicle 200. For example, slide bar 24 is frictionally engaged with housing 20 by at least one friction brake pad 36 and friction brake pad 38. The at least one friction brake pad 36 is disposed within the housing 20 and can include a first friction brake pad 36 disposed along the interconnecting web 28 and a second friction brake pad 38 disposed along the front panel 34 fixed to the C-beam.

Movement of the trailer 100 causes movement of the slide bar 24 which generates frictional forces between the slide bar 24 and the brake pads 36 and 38. These frictional forces resist the lateral sway of the trailer 100.

A user may adjust the amount of sway resistance by adjusting a tensioner 40 including a compression plate 42 and a crank assembly 44. The tensioner 40 is adjusted by changing the orientation of the compression plate 42 relative to the housing 20 using the crank assembly 44. At least a portion of the compression plate 42 is configured to be in contact with the front panel 34 so that pressing the compression plate 42 toward the interconnecting web 28 also presses the front panel 34 toward the interconnecting web 28.

The compression plate 42 is attached to the tow bar assembly 26 by inserting a tab 46 of a distal end 48 into a slot 50 on one of the upper flange 30 and the lower flange 32. A proximal end 52 is mated with the tow bar assembly 26 by threading a mating fastener 54 of the crank assembly 44 through an elongated aperture 56 on the compression plate 42 with a threaded fastener 58 on another of the upper flange 30 and the lower flange 32. The threaded fastener 58 is spaced apart from the slot 50 at a distance corresponding to the width of the housing 20.

The threaded fastener 58, the elongated aperture 56, and the crank assembly 44 constitute a single adjustment point configured to enable adjustable sway reduction of the trailer 100 relative to the towing vehicle 200.

The compression plate 42 spans the width of the housing 20 from the slot 50 to the threaded fastener 58. The compression plate 42 includes a middle portion characterized by a V-shaped ridge 60 running substantially perpendicular to a longitudinal axis defined by a length of the compression plate 42. The V-shaped ridge 60 includes an apex 62 located between two ridge sides, each ridge side being a portion of the compression plate 42 that is oriented at an acute angle relative to a longitudinal axis defined by a length of the compression plate 42 and both ridges meeting at the apex 62 to form an angle of 156 degrees.

A crank handle 64 is used to rotate the mating fastener 54 of the crank assembly 44 in a first or a second direction so as to allow the compression plate 42 to move toward or away from the interconnecting web 28, respectively. Pressing the compression plate 42 toward the interconnecting web 28 increases the relative friction between the slide bar 24 and the housing 20 by increasing the pressure on the at least one brake pad 36. Moving the compression plate 42 away from the interconnecting web 28 decreases the relative friction between the slide bar 24 and the housing 20.

Rotating the crank handle 64 in the first direction, thereby pressing compression plate 42 toward the interconnecting web 28 and increasing the relative friction between the slide bar 24 and the housing 20, reduces the sway of the trailer 100 relative to the towing vehicle 200. Rotating the crank handle 64 in the second direction opposite from the first direction enables removal of the compression plate 42 from the housing 20 when the compression plate 40 is not in use.

Another embodiment may include a sway control 10 for adjustable sway reduction of a trailer 100 relative to a towing vehicle 200. The sway control 10 includes a housing 20 having at least one friction brake pad 36 disposed there within. The housing 20 is formed as a C-beam having an upper flange 30, a lower flange 32, a front panel 34, and an interconnecting web 28.

The sway control 10 further includes a slide bar 24 configured to be slidably mounted within the housing 20 and frictionally engaged with the at least one brake pad 36. The sway control 10 includes a bolt-receiving nut 58 disposed on one of the upper flange 30 and the lower flange 32. The sway control 10 includes a tab-receiving slot 50 formed in another of the upper flange 30 and the lower flange 32.

The sway control 10 includes a pair of connectors 12 for connection between the trailer 100 and the towing vehicle 200. The pair of connectors 12 includes a trailer connector 14 disposed on a trailer end 18 of the housing 20 and a towing vehicle connector 16 disposed on a towing vehicle end 22 of the slide bar 24.

The sway control 10 includes a tensioner 40 including a compression plate 42 and a crank handle 64 having an integral bolt 54. The compression plate 42 spans from the bolt-receiving nut 58 to the tab-receiving slot 50. The compression plate 42 has a first end 52 characterized by an elongated hole 56 configured to align with the bolt-receiving nut 58 and a second end 48 characterized by a tab 46 configured to be inserted into the tab-receiving slot 50.

The crank handle 64 having an integrated bolt 54 is configured to be inserted into and rotated within the elongated hole 56 and the bolt-receiving nut 58. The crank handle 64 is rotatable in a first direction to move at least a portion of the compression plate 42 toward the slide bar 24 to increase compression on the at least one friction brake pad 36. The crank handle 64 is rotatable in a second direction to allow the compression plate 42 to move away from the slide bar 24 to decrease compression on the at least one brake pad 36.

The compression plate 42 is removably attached to the housing 20 so that further rotation of the crank handle 64 in the second direction allows the compression plate 42 to be removed from the housing 20. At least a portion of the compression plate 42 is configured to be in contact with the front panel 34 so that pressing the compression plate 42 toward the interconnecting web 28 also presses the front panel 34 toward the interconnecting web 28. A middle portion of the compression plate 42 is configured to be in contact with the front panel 34, the middle portion being characterized by a V-shaped ridge 60 running substantially perpendicular to a longitudinal axis defined by a length of the compression plate 42.

The at least one friction brake pad 36 includes a first friction brake pad 36 disposed along a first interior side of the interconnecting web 28 and a second friction brake pad 38 disposed along a second interior side of the front panel 34. The pair of connectors 12 include a sway control ball socket 16 disposed on a towing vehicle end 22 of the slide bar 24 and configured to couple with a secondary sway control ball 204 disposed adjacently to a primary hitch ball 208 on a ball mount 206 of the towing vehicle 200. The pair of connectors 12 include a tongue ball socket 14 disposed on a trailer end 18 of the housing 20 and configured to couple with a tongue ball 102 disposed on a tongue 104 of a trailer 100.

Another embodiment may include a friction sway control 10 for adjustable sway reduction of a trailer 100 relative to a towing vehicle 200, where the friction sway control 10 includes a housing 20 formed as a C-beam having an upper flange 30, a lower flange 32, and an interconnecting web 28, and a front panel 34 fixed to the C-beam. The friction sway control 10 further includes a slide bar 24 slidably mounted within the housing 20 and at least one friction brake pad 36 frictionally engaging the housing 20 with the slide bar 24. The friction sway control 10 also includes a pair of connectors 12 for connection between the trailer 100 and the towing vehicle 200, including a trailer connector 14 disposed on a trailer end 18 of the housing 20 and a towing vehicle connector 16 disposed on a towing vehicle end 22 of the slide bar 24.

The friction sway control 10 further includes a single nut 58 disposed on one of the upper flange 30 and the lower flange 32 of the housing 20 and a slot 50 formed on another one of the upper flange 30 and the lower flange 32 spaced apart at a distance corresponding to the width of the housing 20. The friction sway control 10 also includes a compression plate 42 attached to the housing 20 such that the compression plate 42 spans from the nut 58 to the slot 50, including an elongated aperture 56 that aligns with the nut 58 and a tab 46 that fits into the slot 50.

The middle portion of the compression plate 42 is characterized by a V-shaped ridge 60 running substantially parallel to a transverse axis defined by a width of the compression plate 42, including an apex 62 located between two ridge sides, each ridge side being a portion of the compression plate that is oriented at an acute angle relative to a longitudinal axis defined by a length of the compression plate 42, and both ridge sides meeting at the apex 62 to form an angle of 156 degrees.

The friction sway control 10 further includes a crank 44 having a crank handle 64 and a bolt 54, where the bolt 54 extends through the elongated aperture 56 to thread with the nut 58 such that rotating the crank handle 64 adjusts a position of at least a portion of the compression plate 42 relative to the interconnecting web 28 to thereby adjust the frictionally engaging of the housing 20 with the slide bar 24. The elongated aperture 56, the nut 58, and the bolt 54 constitute a single adjustment point that is configured to enable adjustable reduction of the sway of the trailer 100 relative to the towing vehicle 200.

The crank handle 64 is configured to be pivoted about a point defined by the elongated aperture 56 and the nut 58 to adjust the sway of the trailer 100 to a desired level. The crank handle 64 is configured to be pivoted in a first direction to press the compression plate 42 toward the interconnecting web 28 to thereby reduce the sway of the trailer 100 relative to the towing vehicle 200. The crank handle 64 is configured to be pivoted in a second direction to allow the compression plate 42 to move away from the interconnecting web 28 to thereby enable removal of the compression plate 42 from the housing 20 when the compression plate 42 is not in use.

Another embodiment may include a sway control 10 that includes a housing 20 formed as a C-beam having an upper flange 30, a lower flange 32, and an interconnecting web 28, and a slide bar 24 configured to be slidably mounted within the housing 20. The sway control 10 also includes at least one friction brake pad 36 frictionally engaging the housing 20 with the slide bar 24. The sway control 10 further includes a nut 58 disposed on one of the upper flange 30 and the lower flange 32 spaced apart from a slot 50 formed in another of the upper flange 30 and the lower flange 32 at a distance corresponding to a width of the housing 20.

The sway control 10 further includes a compression plate 42 attached to the housing 20, wherein the compression plate 42 includes an elongated aperture 56 that aligns with the nut 58 and a tab 46 that fits into the slot 50. The sway control 10 includes a crank assembly 44 having a crank handle 64 and a mating bolt 54 extending through the elongated aperture 56 of the compression plate 42 to mate with the nut 58, so that rotating the crank handle 64 in a first direction increases compression on the at least one brake pad 36 to increase a relative friction between the slide bar 24 and the housing 20 and rotating the crank handle 64 in a second direction opposite from the first direction decreases compression on the at least one brake pad 36 to decrease the relative friction between the slide bar 24 and the housing 20.

Another embodiment may include a sway control 10 for adjustably reducing sway of a trailer 100 relative to a towing vehicle 200 that includes a tow bar assembly 26 configured to connect a trailer 100 to a towing vehicle 200. The tow bar assembly 26 includes a slide bar 24 slidably mounted within a structural housing 20 and the structural housing 20 having an upper flange 30, a lower flange 32, and an interconnecting web 28. The sway control 10 further includes a bolt-receiving nut 58 disposed on one of the upper flange 30 and lower flange 32 spaced apart from a tab-receiving slot 50 formed in another of the upper flange 30 and lower flange 32 at a distance corresponding to a width of the housing 20.

The sway control 10 further includes a compression plate 42 configured to attach to the housing 20, having a first end 52 characterized by an elongated hole 56 configured to align with the bolt-receiving nut 58 and a second end 48 characterized by a tab 46 configured to be inserted into the tab-receiving slot 50. The compression plate 42 spans from the bolt-receiving nut 58 to the tab-receiving slot 50.

The sway control 10 also includes a crank assembly 44 having a crank handle 64 fixed to a bolt 54 that is extendable through the elongated aperture 56 of the compression plate 42 to mate with the bolt-receiving nut 58. The crank assembly 44 is designed to mate with the bolt-receiving nut 58 such that rotating the crank handle 64 in a first direction moves at least a portion of the compression plate 42 toward the interconnecting web 28 to increase an amount of friction generated between the slide bar 24 and the housing 20, and so that rotating the crank handle 64 in a second direction allows the compression plate 42 to move away from the interconnecting web 28 to decrease the amount of friction generated between the slide bar 24 and the housing 20.

Another embodiment may include a sway control 10 for connection between a trailer 100 and a towing vehicle 200 that includes a tow bar assembly 26. The tow bar assembly 26 includes a slide bar 24 slidably mounted within and frictionally engaged with a housing 20, the housing 20 being formed as a C-beam having an upper flange 30 and a lower flange 32 interconnected by a web 28. The sway control 10 further includes a nut 58 disposed on one of the upper flange 30 and the lower flange 32 of the housing 20 that is spaced apart from a slot 50 formed in another of the upper flange 30 and the lower flange 32 at a distance corresponding to a width of the housing 20.

The sway control 10 further includes a compression plate 42 configured to be attached to the housing 20. The compression plate 42 includes an elongated aperture 56 that aligns with the nut 58 and a tab 46 that fits into the slot 50.

The sway control 10 also includes a crank assembly 44 having a crank handle 64 disposed on a bolt 54. The bolt 54 is configured to extend through the elongated aperture 56 to mate with the nut 58, so that rotating the crank handle 64 in a first direction tightens the bolt 54, and so that rotating the crank handle 64 in a second direction opposite from the first direction loosens the bolt 54. The sway control 10 is configured such that tightening the bolt 54 of the crank assembly 44 moves at least a portion of the compression plate 42 toward the web 28 to increase a relative friction between the slide bar 24 and the housing 20, and loosening the bolt 54 allows the compression plate 42 to move away from the web 28 to decrease the relative friction between the slide bar 24 and the housing 20.

Yet another embodiment may include a sway control 10 for adjustably reducing sway of a trailer 100 relative to a towing vehicle 200 that includes a structural housing 20. The structural housing 20 includes at least one friction brake pad 36 disposed there within and is formed as a C-beam having an upper flange 30, a lower flange 32, and an interconnecting web 28. The sway control 10 also includes a side bar 24 configured to be slidably mounted within the housing 20 and frictionally engaged with the at least one brake pad 36.

The sway control 10 also includes a pair of connectors 12. The pair of connectors 12 includes a trailer connector 14 disposed on a trailer end 18 of the slide bar 24 and a towing vehicle connector 16 disposed on a towing vehicle end 22 of the housing 20. The sway control 10 further includes a bolt-receiving nut 58 disposed on one of the upper flange 30 and the lower flange 32 and a tab-receiving slot 50 disposed on another of the upper flange 30 and the lower flange 32 spaced apart at a distance corresponding to a width of the housing 20.

The sway control 10 also includes a compression plate 42 configured to be attached to the housing 20. The compression plate 42 has an elongated aperture 56 that aligns with the nut 58 and a tab 46 that is insertable into the tab-receiving slot 50.

The sway control 10 also includes a crank assembly 44 having a crank handle 64 disposed on a mating bolt 54. The mating bolt 54 is configured to extend through the elongated aperture 56 to mate with the nut 58. The crank assembly 44 is configured to enable adjustment of an amount of friction generated between the compression plate 42 and the housing 20 by adjusting a position of at least a portion of the compression plate 42 relative to the web 28.

The crank assembly 44 is further configured such that rotating the crank handle 64 in a first direction pressed the compression plate 42 toward the web 28 to compress the at least one friction brake pad 36. The crank assembly 44 is also configured such that rotating the crank handle 64 in a second direction opposite from the first direction allows the compression plate 42 to move away from the web 28 to allow the at least one friction brake pad 36 to expand.

Yet another embodiment may include a sway control 10 including a structural housing 20 formed as a C-beam having an upper flange 30 and a lower flange 32 that are interconnected by a web 28. The sway control 10 further includes a slide bar 24 configured to be slidably mounted within the housing 20 and frictionally engaged with the housing 20. The sway control 10 also includes a bolt-receiving nut 58 disposed on one of the upper flange 30 and the lower flange 32 and a tab-receiving slot 50 disposed on another one of the upper flange 30 and the lower flange 32.

The sway control 10 also includes a sway control ball socket 16 disposed on a towing vehicle end 22 of the slide bar 24 and configured to connect to a sway control ball 204 of a towing vehicle 200. The sway control 10 also includes a tongue ball socket 14 disposed on a trailer end 18 of the housing 20 and configured to connect to a tongue ball 102 of a trailer 100.

The sway control 10 further includes a compression plate 42 configured to be attached to the housing 20, having an elongated aperture 56 that aligns with the nut 58 and a tab 46 that is insertable into the slot 50. The sway control 10 also includes a crank 44 having a crank handle 64 fixed to a bolt 54. The bolt 54 is configured to extend through the elongated aperture 56 to mate with the nut 58 so that rotating the crank 44 adjusts a position of at least a portion of the compression plate 42 relative to the web 28 to adjust an amount of friction generated between the slide bar 24 and the housing 20.

The adjustment of the compression plate 42 relative to the web 28 controls the sway of the trailer 100 relative to the towing vehicle 200. When the crank 44 is rotated in a first direction, the amount of friction generated between the slide bar 24 and the housing 20 increases. Rotating the crank 44 in a second direction opposite from the first direction decreases the amount of friction generated between the slide bar 24 and the housing 20.

Yet another embodiment may include a sway control 10 for connecting a trailer 100 to a towing vehicle 200 that includes a housing 20 formed as a C-beam having an upper flange 30, a lower flange 32, and an interconnecting web 28 and a slide bar 24 configured to be slidably mounted within the housing 20 and frictionally engaged with at least one friction brake pad 36 disposed within the housing 20. A sway control ball socket 16 is disposed on a towing vehicle end 22 of the slide bar 24 and is configured to couple with a sway control ball 204 attached to a ball mount 206 of the towing vehicle 200. A tongue ball socket 14 is disposed on a trailer end 18 of the housing 20 and is configured to couple with a tongue ball 102 attached to a tongue 104 of the trailer 100.

The sway control 10 further includes a single nut 58 disposed on one of the upper flange 30, fixedly attached to the housing 20, and the lower flange 32 and a tab-receiving slot 50 disposed on another of the upper flange 30 and the lower flange 32. The sway control 10 also includes a compression plate 42 spanning from the single nut 58 to the slot 50. The compression plate 42 includes an elongated hole 56 that aligns with the nut 58 and a tab 46 that fits into the slot 50.

The compression plate 42 is characterized by a V-shaped ridge running substantially perpendicular to a longitudinal axis defined by a length of the compression plate 42. The V-shaped ridge 60 includes an apex 62 located between two ridge sides, including a first ridge side and a second ridge side, each ridge side being a portion of the compression plate 42 that is oriented at an acute angle relative to a longitudinal axis defined by a length of the compression plate 42. Both ridge sides meet at the apex 62 to form an obtuse angle with each other.

The sway control 10 includes a crank 44 having a crank handle 64 fixedly attached to a mating bolt 54 configured to extend through the elongated hole 56 to mate with the nut 58. The crank 44 is configured such that rotating the crank handle 64 in a first direction presses the compression plate 42 toward the slide bar 24 to increase compression on the at least one brake pad 36, thereby increasing the relative friction between the slide bar 24 and the housing 20. The crank 44 is also configured such that rotating the crank handle 64 in a second direction opposite from the first direction allows the compression plate 42 to move away from the slide bar 24 to decrease compression on the at least one brake pad 36, thereby decreasing the relative friction between the slide bar 24 and the housing 20.

Rotation of the crank handle 64 adjusts the lateral movement of the towed vehicle 100 to the desired level of a user. Rotation of the crank handle 64 in the first direction tightens the bolt 54 and increases the pressure exerted on the slide bar 24 by the compression plate 42 and thereby reduces lateral movement of the towed vehicle 100. Rotation of the crank handle 64 in the second direction loosens the bolt 54 and decreases the pressure exerted on the slide bar 24 by the compression plate 42. Rotation of the crank handle 64 in the second direction also enables the removal of the compression plate 42 from the housing 20 when the compression plate 42 is not in use.

The following paragraphs may provide further information regarding example embodiments.

While embodiments of a friction sway control have been particularly shown and described, many variations may be made therein. This disclosure may include one or more independent or interdependent embodiments directed to various combinations of features, functions, elements and/or properties. Other combinations and sub-combinations of features, functions, elements and/or properties may be claimed later in a related application. Such variations, whether they are directed to different combinations or directed to the same combinations, whether different, broader, narrower or equal in scope, are also regarded as included within the subject matter of the present disclosure. Accordingly, the foregoing embodiments are illustrative, and no single feature or element, or combination thereof, is essential to all possible combinations that may be claimed in this or a later application.

It is believed that the disclosure set forth herein encompasses multiple distinct inventions with independent utility. While each of these inventions has been disclosed in its preferred form, the specific embodiments thereof as disclosed and illustrated herein are not to be considered in a limiting sense as numerous variations are possible. Each example defines an embodiment disclosed in the foregoing disclosure, but any one example does not necessarily encompass all features or combinations that may be eventually claimed. Where the description recites “a” or “a first” element or the equivalent thereof, such description includes one or more such elements, neither requiring nor excluding two or more such elements. Further, ordinal indicators, such as first, second or third, for identified elements are used to distinguish between the elements, and do not indicate a required or limited number of such elements, and do not indicate a particular position or order of such elements unless otherwise specifically stated.

1. A sway control for connection between a trailer and a towing vehicle, the sway control comprising:
a housing formed as a C-beam having an upper flange, a lower flange, and an interconnecting web;
a slide bar configured to be slidably mounted within the housing and frictionally engaged with the housing;
a threaded fastener fixed to one of the upper flange and the lower flange;
a slot formed in another of the upper flange and the lower flange;
a compression plate spanning from the threaded fastener to the slot, and including a tab that fits into the slot and an elongated hole that aligns with the threaded fastener; and
a crank assembly having a crank handle and a mating fastener that threads with the threaded fastener, wherein one of the mating fastener or the threaded fastener extends through the elongated hole, so that the mating fastener is mated with the threaded fastener;
wherein rotation of the crank handle in a first direction presses the compression plate toward the interconnecting web to increase a relative friction between the slide bar and the housing; and
wherein rotation of the crank handle in a second direction opposite from the first direction allows the compression plate to move away from the interconnecting web to decrease the relative friction between the slide bar and the housing.

2. The sway control according to claim 1, wherein the threaded fastener is spaced apart from the slot at a distance corresponding to a width of the housing.

3. The sway control according to claim 1, further comprising at least one friction brake pad frictionally engaging the housing with the slide bar.

4. The sway control according to claim 3, wherein the at least one friction brake pad is disposed within the housing and includes a first friction brake pad disposed along the interconnecting web, and a second friction brake pad disposed along a front panel that is fixed to the C-beam.

5. The sway control according to claim 1, wherein the compression plate includes a middle portion characterized by a V-shaped ridge running substantially perpendicular to a longitudinal axis defined by a length of the compression plate.

6. The sway control according to claim 1, further comprising a sway control ball socket disposed on a towing vehicle end of the slide bar and configured to couple with a sway control ball disposed on a ball mount of the towing vehicle.

7. The sway control according to claim 1, further comprising a tongue ball socket disposed on a trailer end of the housing and configured to couple with a tongue ball disposed on a tongue of the trailer.

8. The sway control according to claim 1, wherein the threaded fastener, the elongated hole, and the crank handle constitute a single adjustment point configured to enable adjustable sway reduction of the trailer relative to the towing vehicle.

9. A sway control for controlling sway of a trailer relative to a towing vehicle, the sway control comprising:
a tow bar assembly including a slide bar slidably mounted within and frictionally engaged with a housing, the housing having at least one friction brake pad and being formed as a C-beam having an upper flange and a lower flange interconnected by a web;
a single nut disposed on one of the upper flange and the lower flange of the housing, the nut being spaced apart from a slot formed in another of the upper flange and the lower flange of the housing a distance corresponding to a width of the housing;
a compression plate configured to be attached to the housing so that the compression plate spans from the nut to the slot, wherein the compression plate includes an elongated aperture that aligns with the nut and a tab that is insertable into the slot; and
a crank assembly having a crank handle disposed on a bolt configured to extend through the elongated aperture to mate with the nut, so that rotating the crank handle in a first direction increases compression on the at least one friction brake pad to increase a relative friction between the slide bar and the housing, and so that rotating the crank handle in a second direction decreases compression on the at least one friction brake pad to decrease the relative friction between the slide bar and the housing;
wherein the aperture, the nut, and the bolt constitute a single adjustment point that is configured to enable adjustable reduction of the sway of the trailer relative to the towing vehicle.

10. The sway control according to claim 9, wherein the crank handle is configured to be pivoted about a point defined by the aperture and the nut to adjust the sway of the trailer to a desired level.

11. The sway control according to claim 10, wherein the crank handle is configured to be pivoted in the first direction to press the compression plate toward the web to thereby reduce the sway of the trailer relative to the towing vehicle.

12. The sway control according to claim 10, wherein the crank handle is configured to be pivoted in the second direction to allow the compression plate to move away from the web to thereby enable removal of the compression plate from the housing when the compression plate is not in use.

13. The sway control according to claim 9, wherein a middle portion of the compression plate is characterized by a V-shaped ridge running substantially perpendicular to a longitudinal axis defined by a length of the compression plate.

14. The sway control according to claim 9, further comprising a tongue ball socket disposed on a trailer end of the housing and configured to couple with a tongue ball attached to a tongue of the trailer.

15. A sway control for adjustable sway reduction of a trailer relative to a towing vehicle, the sway control comprising:
a housing having at least one friction brake pad disposed therewithin, the housing being formed as a C-beam having an upper flange, a lower flange, a front panel and an interconnecting web;
a slide bar configured to be slidably mounted within the housing and frictionally engaged with the at least one friction brake pad;
a bolt-receiving nut disposed on one of the upper flange and the lower flange;
a tab-receiving slot formed in another of the upper flange and the lower flange;
a pair of connectors for connection between the trailer and the towing vehicle, including a trailer connector disposed on a trailer end of the housing and a towing vehicle connector disposed on a towing vehicle end of the slide bar; and
a tensioner including:
a compression plate spanning from the bolt-receiving nut to the tab-receiving slot, and having a first end characterized by an elongated hole configured to align with the bolt-receiving nut, and a second end characterized by a tab configured to be inserted into the tab-receiving slot, and
a crank assembly, including a crank handle having an integral bolt configured to be inserted into and rotated within the elongated hole and the bolt-receiving nut, the crank handle being rotatable in a first direction to move at least a portion of the compression plate toward the slide bar to increase compression on the at least one friction brake pad, and rotatable in a second direction to allow the compression plate to move away from the slide bar to decrease compression on the at least one friction brake pad.

16. The sway control according to claim 15, wherein the compression plate is removably attached to the housing so that further rotation of the crank handle in the second direction allows the compression plate to be removed from the housing.

17. The sway control according to claim 15, wherein at least a portion of the compression plate is configured to be in contact with the front panel, so that pressing the compression plate toward the interconnecting web also presses the front panel toward the interconnecting web.

18. The sway control according to claim 15, wherein a middle portion of the compression plate is configured to be in contact with the front panel, the middle portion being characterized by a V-shaped ridge running substantially perpendicular to a longitudinal axis defined by a length of the compression plate.

19. The sway control according to claim 15, wherein the at least one friction brake pad includes a first friction brake pad disposed along a first interior side of the interconnecting web and a second friction brake pad disposed along a second interior side of the front panel.

20. The sway control according to claim 15, wherein the pair of connectors include a sway control ball socket disposed on a towing vehicle end of the slide bar and configured to couple with a secondary sway control ball disposed adjacently to a primary hitch ball on a ball mount of the towing vehicle and a tongue ball socket disposed on a trailer end of the housing and configured to couple with a tongue ball disposed on a tongue of the trailer.
